(19) United States
(12) Patent Application Publication
(10) Pub. No.: US 2016/0110809 A1
(43) Pub. Date: Apr. 21, 2016

(54) Increasing Value Handbag

(71) Applicant: Wesley Zhou, Laguna Niguel, CA (US)

(72) Inventor: Wesley Zhou, Laguna Niguel, CA (US)

(21) Appl. No.: 14/515,251

(22) Filed: Oct. 15, 2014

(51) Int. Cl. G06Q 40/06; A45C 15/00; A45C 3/06

(52) U.S. Cl. CPC G06Q 40/06; A45C 3/06; A45C 15/00

(57) ABSTRACT

Apparatus comprising an electronic device in a handbag configured to communicate with a mobile device in order to update and display a portfolio value on a display device; the mobile device including a software application configured to automatically update the portfolio value by connecting to an online database.

### BACKGROUND OF THE DISCLOSURE

1. Field of the Disclosure

The subject disclosure relates to a handbag with a built-in display which shows, for example, the value of an investment portfolio that is linked to the handbag.

2. Related Art

Handbags per se of many designs are known in the art.

### SUMMARY

According to an illustrative embodiment the apparatus comprises of a handbag made of leather or other material that incorporates an electronic device which has an LCD or other technology display. In one embodiment, the device links with a paired mobile phone via Bluetooth. In one embodiment, the handbag links to an investment portfolio and comes with an accompanying investment portfolio certificate.

### BRIEF DESCRIPTION OF THE DRAWINGS

FIG. 1 is a side perspective view of an illustrative embodiment of a handbag with a built-in electronic device and display with a display cover in an open position;

FIG. 2 is a side perspective view of an illustrative embodiment of a handbag with a built-in electronic device and display with a display cover in a closed position;

FIG. 3 is a system block diagram of the electronics of an illustrative embodiment; and

FIG. 4 and FIG. 5 are flowcharts illustrating functioning of the processors of FIG. 3.

### DETAILED DESCRIPTION

According to one illustrative embodiment, a handbag with a specific serial number is linked to an investment portfolio. In one embodiment, the handbag is equipped with an electronic device with an LCD E-ink or other display, and may have an activation button that allows the device to pair with a mobile telephone, as well as a battery pack with replaceable disposable batteries.

According to an illustrative business method, a handbag is offered for sale equipped as described, along with a linked investment portfolio. The buyer takes ownership of the handbag and is sent a Certified Investment Portfolio Certificate and Insurance Certificate, for example, within ten days of the purchase date.

According to one embodiment, two investment options are provided to the buyer: The first option is a guaranteed value increase option. In this case, the owner decides to have the portfolio invested in Bonds or CD/Fixed Deposits or a similar investment instrument or a combination of these. When returning the handbag along with the Investment Certificate, which, in one embodiment, can be done at any time, the full current value is refunded minus a fee of, for example, $2,000.00 which covers the cost of the handbag and a management fee. The second investment option is to have all the investments in stocks or Mutual Funds or a combination of these. In this case, the bag can only be returned after a minimum time period of, for example, one year, and the fee, which covers the cost of the handbag and a management fee may be, for example, 25% of any value added to the value of the investment. According to one embodiment, all Financial Transactions related to the Investments may be CPA and Attorney Certified.

In one embodiment, the company that sells the handbag will be taking out an insurance policy for each buyer that guarantees payout of the current value of the investments in case of insolvency of the company.

In one embodiment, for the owner to able to convert the investment into cash again, the owner must surrender the handbag together with the accompanying Certified Investment Portfolio Certificate. There can be no payout on only the handbag, or on only the Certified Investment Portfolio Certificate.

The electronic technology used to implement an illustrative embodiment may comprise a Software application that is running on a mobile telephone or similar piece of equipment that enables Bluetooth pairing with the electronic device inside the handbag. The Software application monitors the value of the investments for the owner. When the button on the electronic device in the handbag is activated, the device pairs to the mobile telephone, retrieves the current value of the investments, and displays that value on the display device, after which the Bluetooth connection is terminated until it is again initiated by the owner. Of course, the display device may be controlled so as to display a succession of included values and/or other information in other embodiments.

In one embodiment, there may be four levels or categories for these Investment handbags: Silver at a price of $25,000.00, Gold at a price of $50,000.00, Platinum costing $100,000.00 and Diamond at $250,000.00.

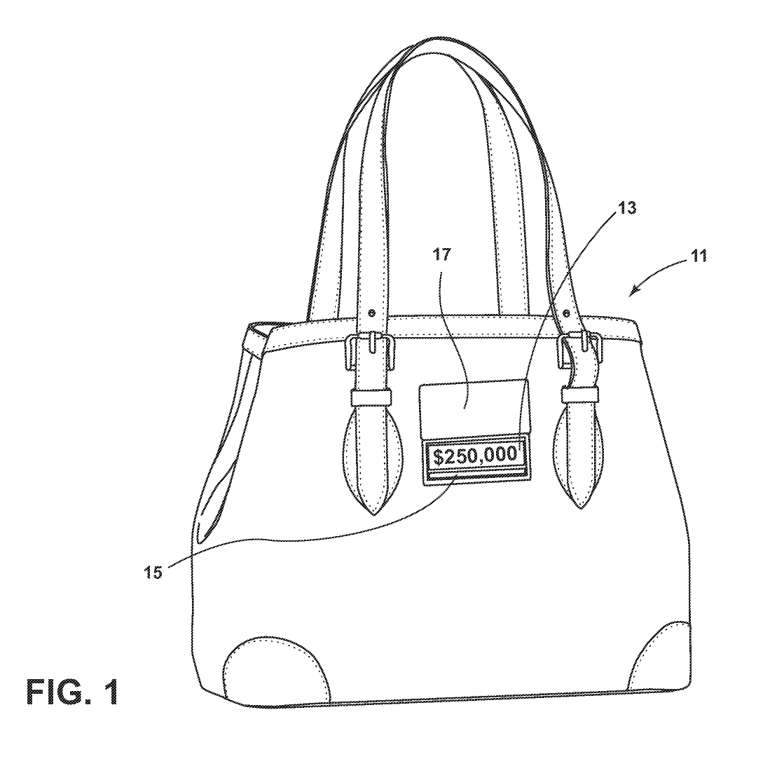

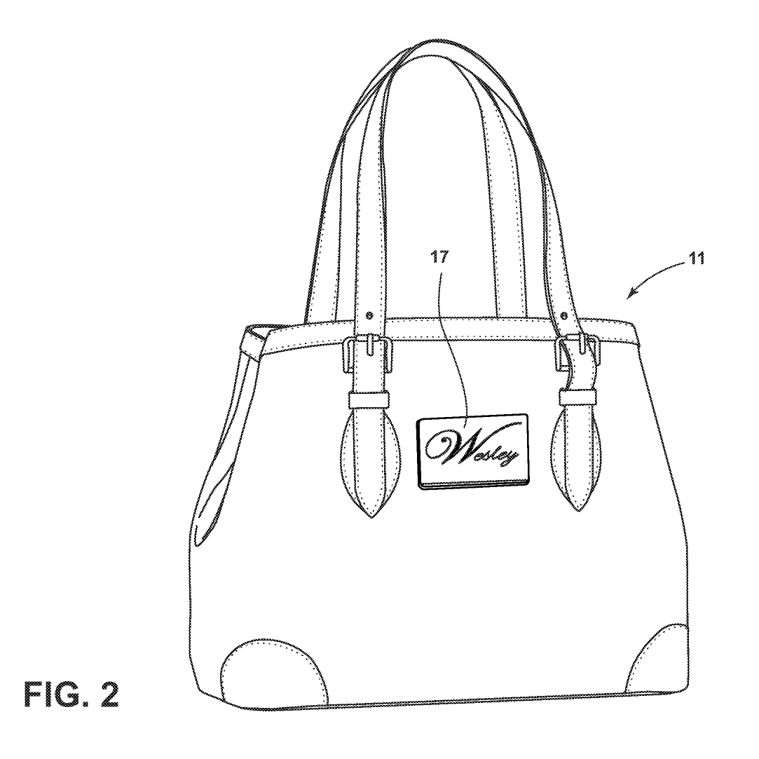

FIG. 1 shows an illustrative handbag 11, with a display 13 beneath which is positioned an activation button 15. In one embodiment, a cover 17 may be flipped open to reveal the display 13 or to cover the display 13, as shown in FIG. 2. In one embodiment, the display 13 may be driven by a communication device and activated to provide a display upon depression or other activation of the button 15 or by touching touch screen display.

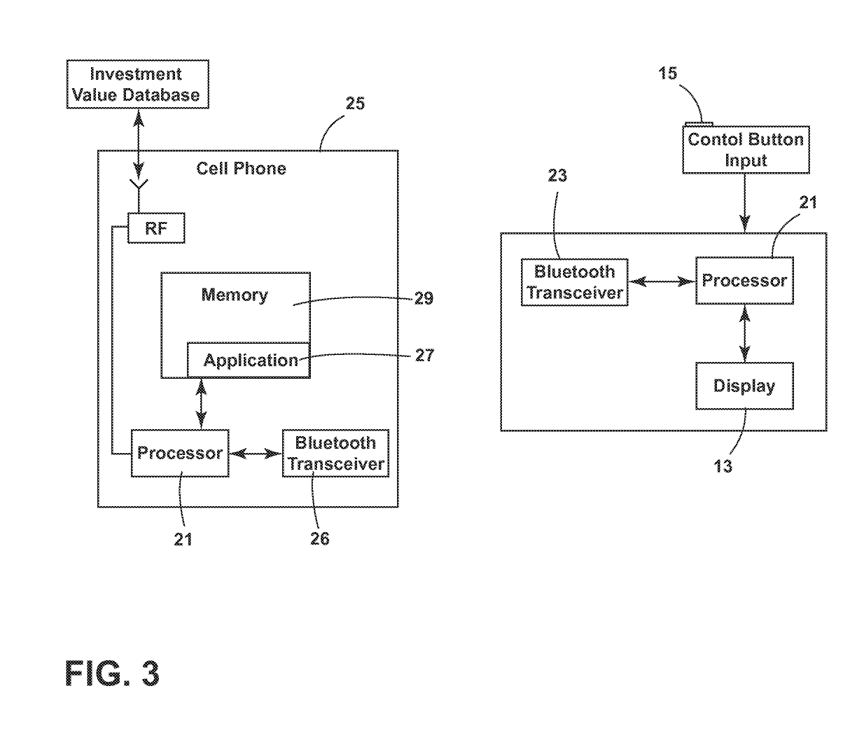

As shown in FIG. 3, the display 13 is connected to a processor 21, which may be, for example, a microprocessor, microcontroller, custom integrated circuit, or computing device. The processor 21 is connected to interface with a Bluetooth or other transceiver 23, for the purpose of transmitting and receiving RF communications, for example, from a handheld device 25, which may be, for example, a cell phone or smart phone. In other embodiments, the device 25 need not be handheld. The device 25 also includes a Bluetooth transceiver 26, as well as a software application 27 stored, for example, in a memory 29.

In one embodiment, the transceiver 26 is controlled by a microprocessor or other control device 29 which executes the instructions of the software application to perform a sequence of operations as hereafter described. In particular, in one embodiment, the control device 29 is operative to respond to a signal from the Bluetooth transceiver 23 initiated by depression of the control button 15 to access and retrieve the value of investments selected by the owner of the handbag 11, which value may be stored in a database 30.

In one embodiment, the database 30 is maintained by the company selling the handbag 11. In one embodiment, the database 30 can be updated by various means, for example, by an automatic sync operation with a brokerage computer system where the handbag owner's portfolio resides.

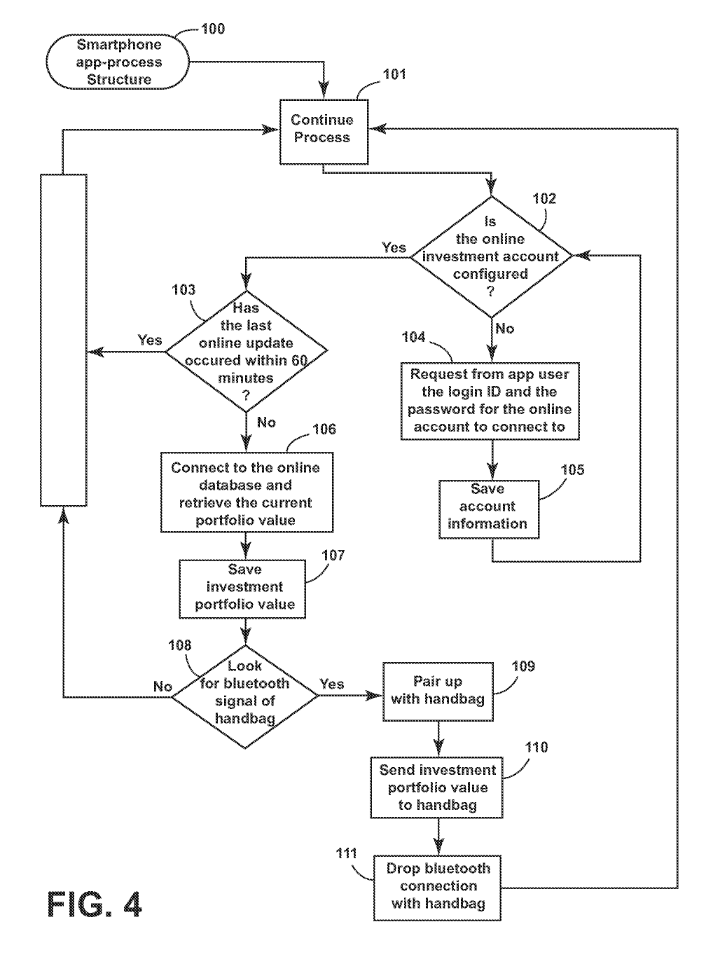

FIG. 4 shows an illustrative structure 100 of a smartphone application 27. In step 102, the system checks to see if the handbag on-line account has been configured within the smart phone application. If not, steps 104 and 105 are executed to allow the user to enter a user log-in I.D. and password and to then save these in the smart phone application.

If at test 102, it is determined that the handbag account has already been configured, test 103 is performed to determine whether the account value information has been updated within a selected interval, such as, for example, 60 minutes. If not, the phone 25 connects to the database 30 and retrieves and saves the current portfolio value as reflected by steps 106, 107. At test 108, the application checks for a Bluetooth signal from the handbag 11. If such a signal is detected, the Bluetooth transceiver 26 of the phone 25 pairs up with the Bluetooth transceiver 23 of the handbag 11 and transmits the investment portfolio value to the handbag 11, steps 109, 110, and then drops or terminates the Bluetooth connection, step 111. If a Bluetooth signal is not detected at test 108, the process continues, step 101.

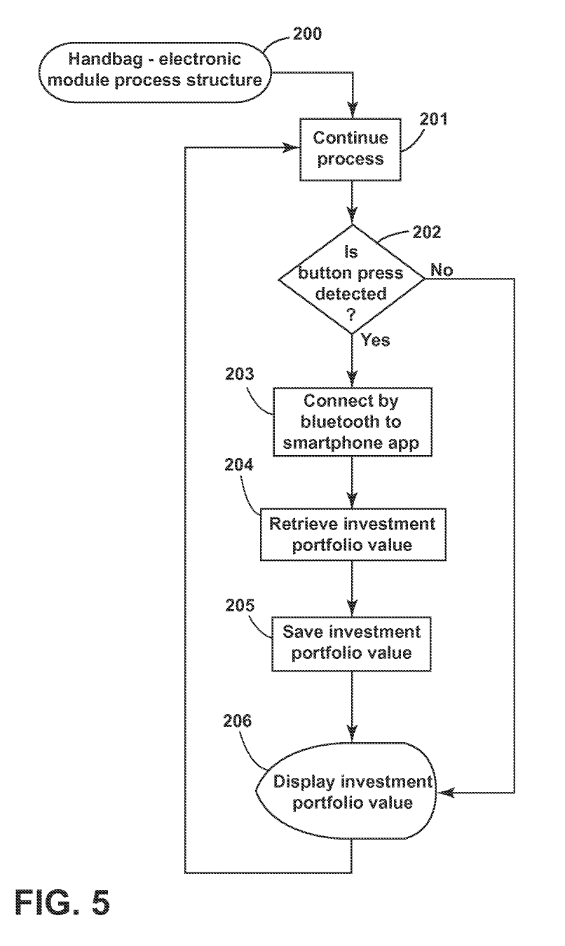

The operation of the handbag processor 21 is further illustrated in FIG. 5. According to the module process structure 200, the processor 21 runs a test 202 to detect depression of the activation button 15. If depression is detected, step 203 is performed to establish a Bluetooth link-up with the phone 25, and to then receive, save, and display the investment portfolio value, steps 204, 205, 206. After step 206, the process continues, step 201.

In various embodiments, more than one investment value may be displayed, as well as other information. In one embodiment, GPS capability could further be provided by the electronic device of the handbag 11 to assist in recovery of a lost or stolen handbag. The method and apparatus disclosed herein may also be used with wallets and briefcases. In other words, handbag 11 could be replaced in other embodiments by a wallet or briefcase equipped with an electronic device 15 and display 13.

In various embodiments, software for implementing the disclosed processes, procedures and functionality described above may be stored on various forms of computer readable medium or media or computer readable storage medium or media. For the purposes of this disclosure, a computer readable medium stores computer data, which data can and typically does include computer program code that is executable by a computer, in machine readable form. In one embodiment, such software and/or program code comprises non-transitory software and/or non-transitory program code.

By way of example, and not limitation, a computer readable medium may comprise computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable storage media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other physical or material medium which can be used to tangibly store the desire information or data or instructions and which can be accessed by a computer or processor. In various embodiments, when suitable computer program code is loaded into and executed by a computer, the computer becomes a specially configured apparatus.

Those skilled in the art will appreciate that various adaptations and modifications of the just described illustrative embodiments can be configured without departing from the scope and spirit of the invention. Therefore, it is to be understood that, within the scope of the appended claims, the invention may be practiced other than as specifically described herein.

What is claimed is:

1. A business method comprising:
selling a handbag with an accompanying Investment Certificate;
accepting surrender of the handbag and Investment Certificate for cash when selected criteria are met; and
linking the handbag value to one or more investment instruments.

2. The method of claim 1 wherein the investment instrument comprises one or more of (a) stocks, (b) bonds, (c) mutual funds, or (d) CD or Fixed Deposit accounts.

3. Apparatus comprising:
an electronic device including a display device in a handbag, the electronic device being configured to communicate with a mobile device in order to update and display an investment value on the display device; and
a software application on the mobile device configured to automatically update the investment value by connecting to an online database.

4. The apparatus of claim 3 wherein said mobile device is a mobile telephone.

5. The apparatus of claim 3 wherein the investment value is a portfolio value.

6. Apparatus comprising:
a handbag; and
an electronic device including a display device in the handbag, the electronic device being configured to communicate with a mobile device in order to update and display a value of an investment on the display device.

7. The apparatus of claim 6 wherein the investment value is a portfolio value.
